(19) United States
(12) Patent Application Publication
(10) Pub. No.: US 2012/0219770 A1
(43) Pub. Date: Aug. 30, 2012

(54) Calico and the Method for manufacturing coloured fabrics

(76) Inventors: Chiu Hsiung Tsai, Tao Yuan County (TW); Fong Ying Tien, Tao Yuan County (TW); Wan Shan Chang, Tao Yuan County (TW); Mou Chuan Huang, Tao Yuan County (TW)

(21) Appl. No.: 13/036,335

(22) Filed: Feb. 28, 2011

(51) Int. Cl. B32B 3/10; B32B 38/14

(52) U.S. Cl. 428/196; 156/277

(57) ABSTRACT

A method is provided for manufacturing calico and coloured fabrics, including the following steps: design a pattern and providing a waterproof and breathable membrane; by using digital ink-jet printing technology to print the said design pattern on the one side of the said waterproof and breathable membrane and checking the color of the pattern providing a fabric, said fabric is without any color and pattern, and the said fabric is a low denier filament fabric or perspective fabric laminating the patterned side of the said waterproof and breathable patterned membrane together with the said fabric, and the pattern of the said waterproof and breathable membrane can be seen through the said fabric. Thereby, to strengthening the color fastness to washing, color fastness to water, color fastness to light, and color fastness to crocking of the calico, reducing the manufacturing procedure and cost, and without any pollution.

### (a) TECHNICAL FIELD OF THE INVENTION

The present invention relates to a Calico and the Method for manufacturing coloured fabrics, the method is based on printing a pattern on a waterproof and breathable membrane by using digital ink-jet printing technology, and laminating the membrane together with a colorless and patternless fabric in order to form a calico.

### (b) DESCRIPTION OF THE PRIOR ART

FIG. 1 is a flow chart of a method for manufacturing calico of the prior art. to manufacture a calico in the traditional way, you have to make a pattern printing plate, and size mixing, after the pattern is print on the fabric by screen printing technique, calico have to go through the steaming process and washing process enable to finish the whole manufacturing process.

In such screen printing technique, you need to have a screen printing plate, and it is made by wooden or metal frame which has the thin mesh nylon and polyester or metal silk fabric tight on it, and coating an opacity non porous membrane on the fabric of the screen printing plate, and remove such opacity membrane on the pattern spot, with only the thin mesh is left on the pattern spot, this spot is where you do the printing. In the most of the case, the fabric of the screen printing plate is coating with an photosensitivity membrane, and removing the membrane on the pattern spot by sensitometry to show the pattern, place the screen printing plate on the fabric which is ready to be print, and pour the print paste inside the printing frame, so the scraper can make the print paste pass through the thin mesh.

There are three common techniques for screen printing: flat screen printing, rotary screen printing, and roller printing.

The flat screen printing technique is to print the pattern by using flat screen printing machine, the conveyor on the flat screen printing machine send the fabric to the screen printing plate, and the fabric stop under the screen printing plate, the scraper on the screen printing machine scrap the pattern on the fabric and move to the next printing frame.

The rotary screen printing technique is using continuous process. The conveyor send the screen printing plate to the rotary cylinder which is in constant motion, and print the pattern on the fabric.

The roller printing technique is also using continuous process, it is more like printing an news paper, the pattern on the copper printing roller roll over the fabric and print the pattern on the fabric.

Even though all the above techniques can achieve the objective of printing pattern on the fabric, but they all have the complexity work of plate making, it is not only takes a lot time to making the plate and the cost is also very high and a big working space is also necessary. According to the statistics, in the last 10 years, the market of calico is decrease. The main reason is that the pace of the modern society is changing fast, same pattern can not be use over and over again, therefore, the screen printing which have the long manufacturing hour and high cost is no longer satisfies the manufacture of calico today.

Also, the color can easily goes off when you print the pattern straight on the fabric.

These are the problem of manufacture of calico in traditional way.

### SUMMARY OF THE INVENTION

In view of the above drawbacks, an objective of the present invention is to provide a Calico and the Method for manufacturing coloured fabrics which can strengthening the color fastness to washing, color fastness to water, color fastness to light, and color fastness to crocking of the calico, and reducing the manufacturing procedure and cost.

To achieve the above objectives, the present invention provides a Calico and the Method for manufacturing coloured fabrics, comprising the following steps:

(1) design a pattern;

(2) providing a waterproof and breathable membrane;

(3) by using digital ink-jet printing technology to print the said design pattern on the one side of the said waterproof and breathable membrane;

(4) checking said calico pattern and colour gamut;

(5) providing a fabric, said fabric is without any color and pattern, and the said fabric is a low denier filament fabric or perspective fabric; and

(6) laminating the patterned side of the said waterproof and breathable patterned membrane together with the said fabric, and the pattern of the said waterproof and breathable membrane can be seen through the said fabric.

Thereby, to strengthening the color fastness to washing, color fastness to water, color fastness to light, and color fastness to crocking of the calico, and reducing the manufacturing procedure and cost, and without any pollution.

Compared to the prior art, the present invention has the following advantages:
1. eliminate the Screen printing plate, avoid the complexity work of plate making
2. the design of printing pattern is without any restriction
3. wider color gamut (basic color gamut are from 4-8), topping is without any restriction
4. full reproducibility of the sample and production sample
5. reducing the time for changing the screen printing plate pattern and color matching
6. easy to clean and with the characteristics of less pollution, Multiple Choices, and fast production for better environmental protection
7. fast production for a calico under 1000 yard
8. good presentation for haft tone pattern
9. no waste products, better environmental protection
10. overcome the problem of low denier filament fabric coloring or pattern printing

In order to make the Examiner clearly understand the contents of the present invention, a detailed description is given below with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a flow chart of a method for manufacturing calico in accordance with an embodiment of the prior art.

FIG. 2 shows a flow chart of a method for manufacturing calico and coloured fabrics in accordance with an embodiment of the present invention.

FIG. 3 shows a decomposition chart of the present invention.

FIG. 4 shows a assembly chart of the present invention.

FIG. 5 shows a cross-sectional chart of the present invention.

FIG. 6 shows a test result of the present invention.

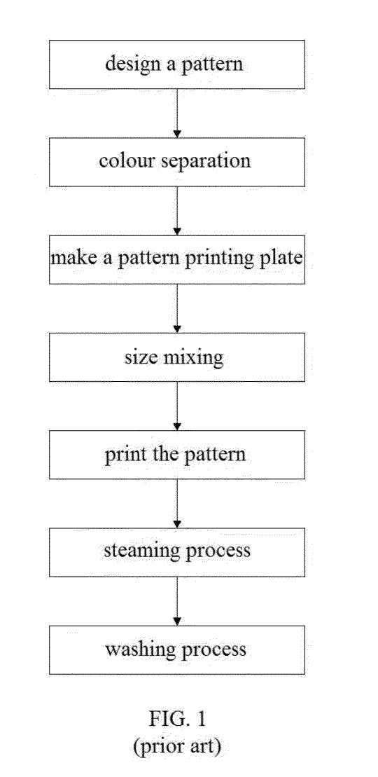

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

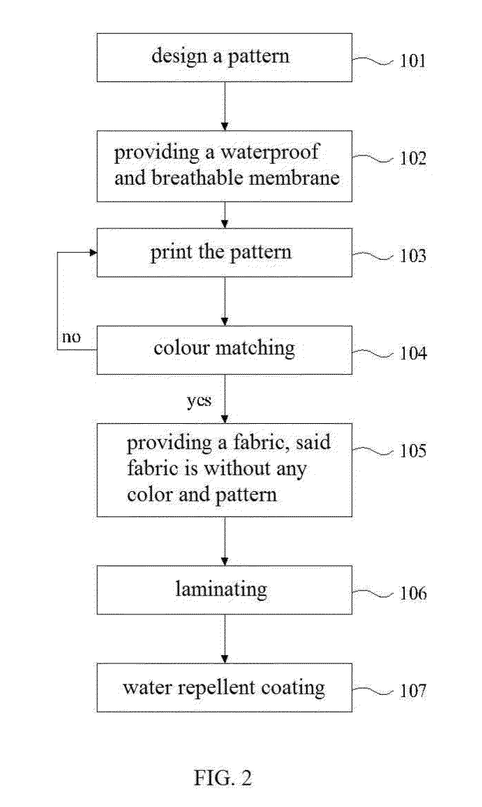

With reference to FIG. 2, a Calico and the Method for manufacturing coloured fabrics in accordance with an embodiment of the present invention is shown. As shown in FIG. 2, the instant embodiment of the Calico and the Method for manufacturing coloured fabrics comprises the following steps:

Step 101, design a pattern;

Step 102, providing a waterproof and breathable membrane, said membrane is at least one selected from non-porous hydrophilic membrane, micro-porous hydrophobic membrane and the composition of both membrane;

Step 103, by using digital ink-jet printing technology to print the said design pattern on the one side of the said waterproof and breathable membrane;

Step 104, checking said calico pattern and colour gamut;

Step 105, providing a fabric, said fabric is without any color and pattern, and the said fabric is a low denier filament fabric or perspective fabric; and

Step 106, laminating the patterned side of the said waterproof and breathable patterned membrane together with the said fabric, and the pattern of the said waterproof and breathable membrane can be seen through the said fabric.

In step 101, said pattern can be an image or an color tone;

In Step 102, said waterproof and breathable membrane is a transparent membrane or non-transparent membrane, and it is selected from polyurethane(PU) non-porous hydrophilic membrane, Polyethylene terephthalate(PET) non-porous hydrophilic membrane, polytetrafluoroethylene(PTFE) micro-porous hydrophobic membrane, polyurethane(PU) micro-porous hydrophobic membrane, and Polyethylene(PE) micro-porous hydrophobic membrane, or the composition of both membrane(non-porous hydrophilic membrane on one side, micro-porous hydrophobic membrane on the other side); the composition of both membrane comprises the following composition:

1. polyurethane(PU) non-porous hydrophilic membrane on one side and polytetrafluoroethylene, (PTFE) micro-porous hydrophobic membrane on the other side.

2. polyurethane(PU) non-porous hydrophilic membrane on one side and polyurethane(PU) micro-porous hydrophobic membrane on the other side.

3. polyurethane, (PU) non-porous hydrophilic membrane on one side and Polyethylene(PE) micro-porous hydrophobic membrane on the other side.

4. Polyethylene terephthalate(PET) non-porous hydrophilic membrane on one side and polytetrafluoroethylene(PTFE) micro-porous hydrophobic membrane on the other side.

5. Polyethylene terephthalate(PET) non-porous hydrophilic membrane on one side and polyurethane, PU micro-porous hydrophobic membrane on the other side.

6. Polyethylene terephthalate(PET) non-porous hydrophilic membrane on one side and Polyethylene(PE) micro-porous hydrophobic membrane on the other side.

In step 103, when during the printing, digital ink-jet printing technology is printing by using a digital ink-jet printer, the said digital ink-jet printer is using print head selected from bubble jet print head or piezoelectric print head. Wherein, said digital ink-jet printer print the digital image designed pattern on the one side of the waterproof and breathable membrane or both side of the waterproof and breathable membrane, digital ink-jet printer is using ink selected from water based ink or Eco solvent ink, said printing procedure can be proceed in a small working space with fast pace, printing 10-80 meters per hour, the design of printing pattern is without any restriction, and no straight contact with the waterproof and breathable membrane during the printing, good presentation and full reproducibility for color tones of the pattern, and the quality of the pattern is 600-1440 dots per inch. The present invention is printing by using digital ink-jet printing technology, compare to the prior art, the present invention does not need the screen print plate, it can reduce a lot of cost for plate making. And the pattern can be print on the one side or both side of the waterproof and breathable membrane.

In step 104, checking said calico pattern and colour gamut, and see if it match with the design pattern, if the pattern and colour gamut is match, proceed step 105, if not, go back to step 103.

In step 105, the said fabric is selected from perspective woven fabric or perspective knitted fabric.

In step 106, said waterproof and breathable membrane and fabric is laminating together by reactive heat-melting adhesive or reactive adhesive, so pattern of the said waterproof and breathable membrane can be seen through the said fabric. Said waterproof and breathable membrane is laminating together with the said fabric by dot lamination or full lamination base on the type of the fabric.

The present invention can strengthening the color fastness to washing, color fastness to water, and color fastness to crocking of the calico, reducing the manufacturing procedure and cost, and without any pollution. Moreover, said method is including a additional step 107, said additional step 107 is by applying an water repellent coating on said calico for a better waterproof effects.

During the manufacture, when the waterproof and breathable membrane is formed, first you have to design the pattern and calculate the amount of ink need to be use, and then print the pattern on the waterproof and breathable membrane by using digital printing, and testing the color fastness to washing, color fastness to water, color fastness to light, and color fastness to crocking of the waterproof and breathable membrane after the printing.

After testing the waterproof and breathable membrane, the type of fabric need to be choose according to the product or client, and what kind of adhesive need to be use, and the coverage rate of the adhesive for laminating the waterproof and breathable membrane and fabric, in order to form a calico, at last, applying an water repellent coating base on the type of fabric.

After the calico is formed, the test should be run again, to qualifies the high standard rating of color fastness to washing, color fastness to water, color fastness to light, and color fastness to crocking of the calico. After the test, the calico can be turn into all kind of textile products.

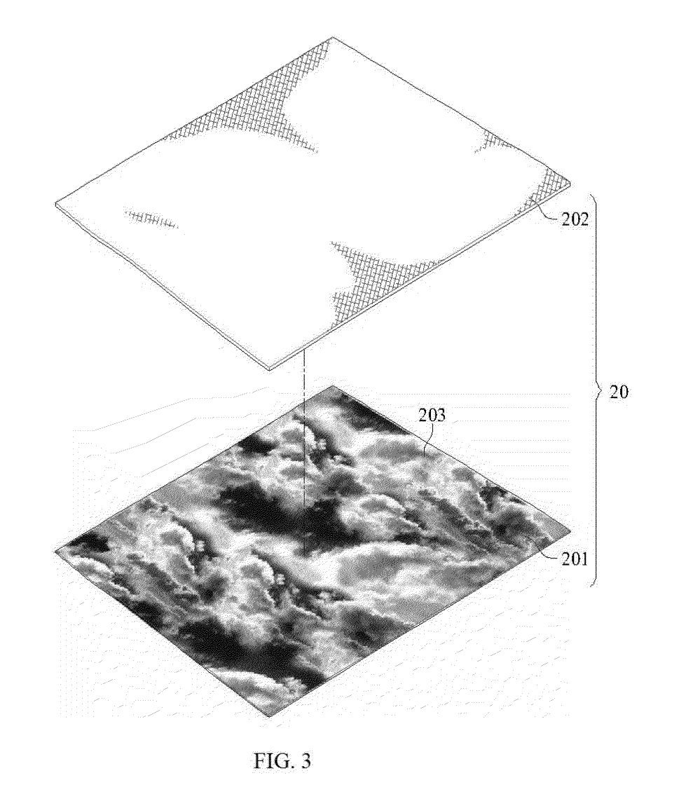

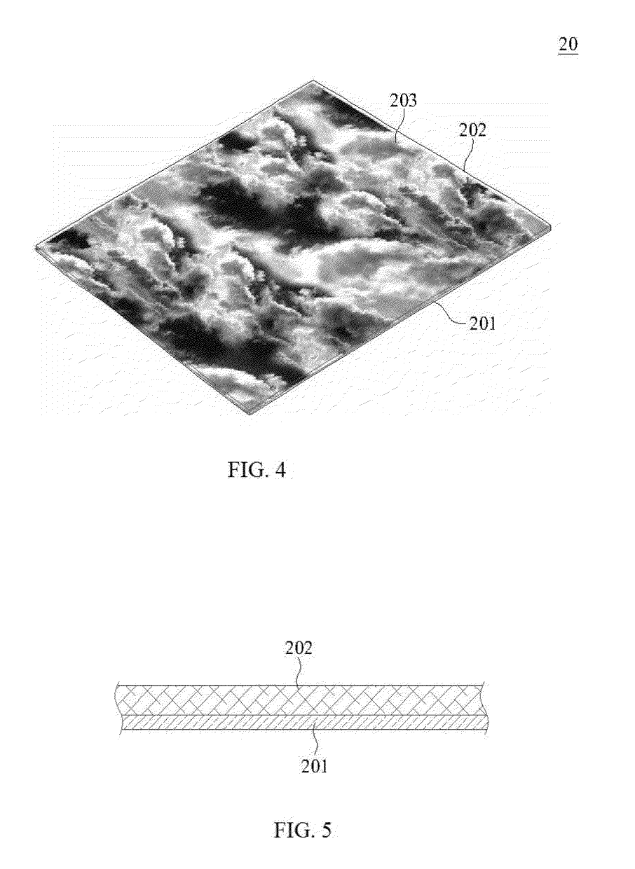

FIG. 3-5 shows a structure chart of a calico after the method for manufacturing calico and coloured fabrics of the present invention. a Calico 20 includes a waterproof and breathable membrane 201 with pattern 203 on it, and a fabric 202 which is without any color and pattern, and the said fabric is a low denier filament fabric 202 or perspective fabric.

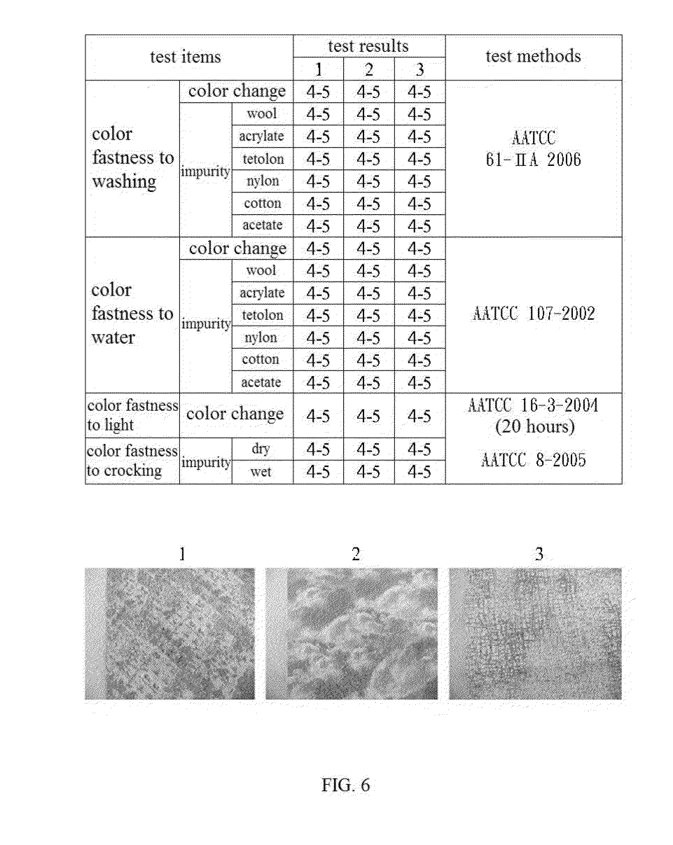

FIG. 6 shows a test result chart of a calico after the method for manufacturing calico and coloured fabrics of the present invention. The waterproof and breathable membrane of the product 1 is an polyurethane(PU) micro-porous hydrophobic membrane, the thickness of the membrane is 30μ (0.030 mm); the fabric is a fifteen denier nylon woven fabric; the pattern is print by Eco solvent ink, and 720 dots per inch. The waterproof and breathable membrane of the product 2 is an polyurethane(PU) non-porous hydrophilic membrane, the thickness of the membrane is 20μ (0.020 mm); the fabric is a twenty denier knitted fabric; the pattern is print by Eco solvent ink, and 720 dots per inch. The waterproof and breathable membrane of the product 3 is an polyurethane(PU) non-porous hydrophilic membrane on one side and polytetrafluoroethylene(PTFE) non-porous hydrophilic membrane on the other side, the thickness of the membrane is 40μ (0.040 mm); the fabric is a twenty denier knitted fabric; the pattern is print by Eco solvent ink, and 720 dots per inch.

As shown in FIG. 6, it is a test result from American association of textile chemists and colorists(AATCC), it shows the colour fatness tests result of product 1-3. The AATCC test method 61-IIA 2006 is to test the color fastness to washing of the calico, the rating depends on the color change of the calico, rating is from 1-5, with less color change, comes with higher rating, the test result of the rating is 4-5 when test with three calico alone and calico with other different calico together. The AATCC test method AATCC 107-2002 is to test the color fastness to water of the calico, the rating depends on the color change of the calico, rating is from 1-5, with less color change, comes with higher rating, the test result of the rating is 4-5 when test with three calico alone and calico with other different calico together. The AATCC test method AATCC 16-3-2004 is to test the color fastness to light of the calico, the rating depends on the color change of the calico, rating is from 1-5, with less color change, comes with higher rating, the test result of the rating is 4-5 when test with three calico alone and calico with other different calico together. The AATCC test method AATCC 16-3-2004 is to test the color fastness to light of the calico, the rating depends on the color change of the calico, rating is from 1-5, with less color change, comes with higher rating, the test result of the rating is 4-5 when test with three calico alone and calico with other different calico together. The AATCC test method AATCC AATCC 8-2005 is to test the color fastness to crocking of the calico, the rating depends on the color change of the calico, rating is from 1-5, with less color change, comes with higher rating, the test result of the rating is 4-5 when test with three calico alone and calico with other different calico together. Thereby to strengthening the color fastness to washing, color fastness to water, and color fastness to crocking of the calico, and reducing the manufacturing procedure and cost, and without any pollution.

Compared to the prior art, the present invention has the following advantages:
1. eliminate the Screen printing plate, avoid the complexity work of plate making
2. the design of printing pattern is without any restriction
3. wider color gamut(basic color gamut are from 4-8), topping is without any restriction
4. full reproducibility of the sample and production sample
5. reducing the time for changing the screen printing plate pattern and color matching
6. easy to clean and with the characteristics of less pollution, Multiple Choices, and fast production for better environmental protection
7. fast production for a calico under 1000 yard
8. good presentation for haft tone pattern
9. no waste products, better environmental protection
10. overcome the problem of low denier filament fabric coloring or pattern printing

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. Calico and the Method for manufacturing coloured fabrics, comprising the following steps:
(1) design a pattern;
(2) providing a waterproof and breathable membrane, said membrane is at least one selected from non-porous hydrophilic membrane, micro-porous hydrophobic membrane and the composition of both membrane;
(3) by using digital ink-jet printing technology to print the said design pattern on the one side of the said waterproof and breathable membrane;
(4) checking said calico pattern and colour gamut;
(5) providing a fabric, said fabric is without any color and pattern, and the said fabric is a low denier filament fabric or perspective fabric; and
(6) laminating the patterned side of the said waterproof and breathable patterned membrane together with the said fabric, and the pattern of the said waterproof and breathable membrane can be seen through the said fabric.

2. The method according to claim 1, wherein the said waterproof and breathable membrane is laminating together with the said fabric by dot lamination.

3. The method according to claim 1, wherein the said waterproof and breathable membrane is laminating together with the said fabric by full lamination.

4. The method according to claim 1, wherein the said waterproof and breathable membrane is a transparent membrane or non-transparent membrane.

5. The method according to claim 1, wherein the said non-porous hydrophilic membrane is made from material selected from Polyurethane(PU) and Polyethylene terephthalate(PET).

6. The method according to claim 1, wherein the said micro-porous hydrophobic membrane is made from material selected from polytetrafluoroethylene(PTFE), polyurethane(PU) and polyethylene(PE).

7. The method according to claim 1, wherein the said composition of both membrane is made from material selected from polyurethane(PU) non-porous hydrophilic membrane on one side and polytetrafluoroethylene(PTFE) micro-porous hydrophobic membrane on the other side.

8. The method according to claim 1, wherein the said composition of both membrane is made from material selected from polyurethane(PU) non-porous hydrophilic membrane on one side and polyurethane(PU) micro-porous hydrophobic membrane on the other side.

9. The method according to claim 1, wherein the said composition of both membrane is made from material selected from polyurethane(PU) non-porous hydrophilic membrane on one side and polyethylene(PE) micro-porous hydrophobic membrane on the other side.

10. The method according to claim 1, wherein the said composition of both membrane is made from material selected from Polyethylene terephthalate(PET) non-porous hydrophilic membrane on one side and polytetrafluoroethylene(PTFE) micro-porous hydrophobic membrane on the other side.

11. The method according to claim 1, wherein the said composition of both membrane is made from material selected from Polyethylene terephthalate(PET) non-porous hydrophilic membrane on one side and polyurethane(PU) micro-porous hydrophobic membrane on the other side.

12. The method according to claim 1, wherein the said composition of both membrane is made from material selected from Polyethylene terephthalate(PET) non-porous hydrophilic membrane on one side and polyethylene(PE) micro-porous hydrophobic membrane on the other side.

13. The method according to claim 1, wherein the said digital ink-jet printing technology is printing by using a digital ink-jet printer.

14. The method according to claim 1, wherein the said design patterns are print on the both side of the said waterproof and breathable membrane.

15. The method according to claim 13, wherein the said digital ink-jet printer is using print head selected from bubble jet print head or piezoelectric print head.

16. The method according to claim 13, wherein the said digital ink-jet printer is using ink selected from water based ink or Eco solvent ink.

17. The method according to claim 13, wherein the said fabric is selected from woven fabric or knitted fabric.

18. The method according to claim 13, wherein the said waterproof and breathable membrane and fabric is laminating together by reactive heat-melting adhesive or reactive adhesive.

19. The method according to claim 13, wherein the said method is including a additional procedure, said additional procedure is by applying an water repellent coating on said calico.
